(19) United States
(12) Patent Application Publication
(10) Pub. No.: US 2008/0107058 A1
(43) Pub. Date: May 8, 2008

(54) METHOD, SYSTEM AND APPARATUS FOR ACQUIRING MULTICAST PROGRAM ADDRESS

(75) Inventors: Jialong YANG, Shenzhen (CN); Xuanyi HUAN, Shenzhen (CN); Xuesong YAN, Shenzhen (CN); Yue WANG, Shenzhen (CN); Wenkui WU, Shenzhen (CN); Weixing ZHANG, Shenzhen (CN); Linhua ZHAO, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/867,966

(22) Filed: Oct. 5, 2007

Related U.S. Application Data
(63) Continuation of application No. PCT/CN2006/002776, filed on Oct. 19, 2006.

(30) Foreign Application Priority Data
Jan. 9, 2006 (CN) 200610000536.9

(51) Int. Cl. H04H 20/71; H04Q 7/20

(52) U.S. Cl. 370/312; 455/466

(57) ABSTRACT

A method for user equipment acquiring a multicast program address includes: receiving, via a Short Massage Service Center (SMSC), an updating program bookmark message containing a multicast program address from an Over The Air (OTA); acquiring the multicast program address from the updating program bookmark message. The present invention also provides a system and an apparatus for user equipment to acquire a multicast program address. With the solution of the present invention, the UE may acquire the multicast program address without network connecting.

This application is a continuation of International Patent Application No. PCT/CN2006/002776, filed Oct. 19, 2006, which claims priority to Chinese Patent Application No. 200610000536.9, filed Jan. 9, 2006, both of which are hereby incorporated by reference.

### FIELD OF THE INVENTION

The present invention relates to the mobile communication technology, and particularly, to a method, a system and an apparatus for acquiring a multicast program address.

### BACKGROUND OF THE INVENTION

Along with the development of mobile communication technology, operators may provide, through a mobile communication network, not only voice and short message services but also stream media multicast and broadcast services for users.

FIG. 1 is a schematic diagram illustrating a typical network structure of a system for implementing a multimedia multicast service. As shown in FIG. 1, the system includes: User Equipment (UE), a Radio Network Controller (RNC), a Serving GPRS Support Node (SGSN), a Gateway GPRS Support Node (GGSN), a Packet Stream Server (PSS) and an End User Portal (EU-portal).

During a multicast service, the UE should acquire a multicast program address first, and then perform the multicast service according to the multicast program address. Generally, the UE may acquire the multicast program address by connecting to the network through the Wireless Application Protocol (WAP). Specifically, the UE sends a browsing request to the EU-Portal via the RNC, SGSN and GGSN in turn; upon the receipt of the browsing request, the EU-Portal returns to the UE a multicast program address list, and then the UE acquires the multicast program address according to the multicast program address list.

After acquiring the multicast program address, the UE may send a multicast service request containing the multicast program address to the RNC, and then the RNC sends multicast service data from a PSS to the UE so as to implement the multicast service.

In the prior art, when a mobile user wants to watch the multicast program, he/she may acquire the multicast program address only by connecting to the network through the WAP. In this manner, the process of acquiring the multicast program address is very complicated and the user experience is unsatisfactory.

### SUMMARY OF THE INVENTION

The present invention provides a method, a system and an apparatus for user equipment acquiring a multicast program address automatically, to avoid the complicated network browsing process.

A method for acquiring a multicast program address includes:

receiving, via a Short Massage Service Center (SMSC), an updating program bookmark message containing a multicast program address from an Over The Air (OTA);

acquiring the multicast program address from the updating program bookmark message.

A system for acquiring a multicast program address includes:

an Over The Air (OTA), capable of sending an updating program bookmark message containing a multicast program address;

User Equipment (UE), capable of receiving the updating program bookmark message from the OTA via a Short Massage Service Center (SMSC), and acquiring the multicast program addresses.

An apparatus for acquiring a multicast program address includes:

a first unit, capable of receiving an updating program bookmark message containing a multicast program address from an Over The Air (OTA) via a Short Massage Service Center (SMSC);

a second unit, capable of acquiring the multicast program address from the updating program bookmark message received by the first unit.

To sum up, according to the method, the system and the apparatus of the present invention, the multicast program address may be sent to the UE via the OTA and the SMAC, so that the UE may acquire the multicast program address without connecting to the network.

### BRIEF DESCRIPTION OF THE DRAWINGS

FIG. 1 is a schematic diagram illustrating a typical network structure of a system for implementing a multimedia multicast service.

FIG. 2 is a flow chart illustrating the method for acquiring a multicast program address in accordance with an embodiment of the present invention.

FIG. 3 is a flow chart of illustrating a method for acquiring a multicast program address in accordance with another embodiment of the present invention.

FIG. 4 is a schematic diagram illustrating a system for acquiring a multicast program address in accordance with an embodiment of the present invention.

FIG. 5 is a schematic diagram illustrating the internal architecture of UE 403 described in FIG. 4 in accordance with an embodiment of the present invention.

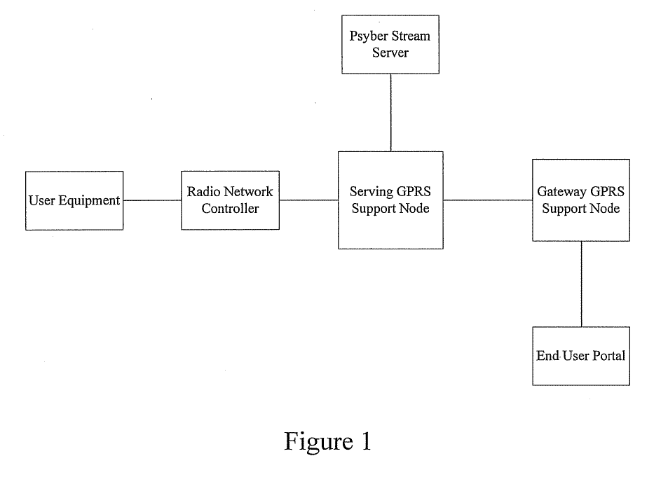

### DETAILED DESCRIPTION OF THE INVENTION

The present invention will be hereinafter described in detail with reference to embodiments and accompanying drawings so as to make the objectives, technical solution and merits of the present invention more apparent.

The embodiments of the present invention include: an OTA sends a message containing a multicast program address to UE via an SMSC, and the UE acquires the multicast program address from the message.

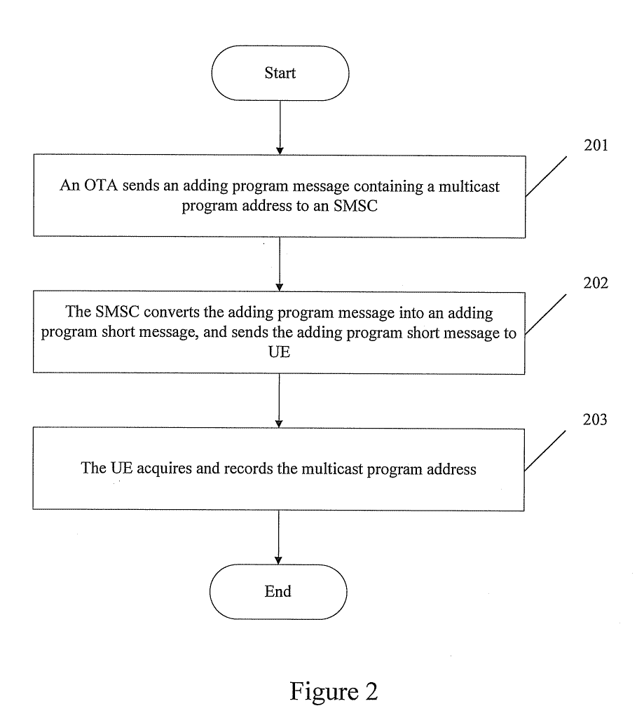

FIG. 2 is a flow chart illustrating the method for UE acquiring a multicast program address in accordance with an embodiment of the present invention. As shown in FIG. 2, the method for the UE acquiring a multicast program address in accordance with an embodiment of the present invention includes the following processes.

Block 201: An OTA sends an adding program message containing a multicast program address to an SMSC.

Block 202: The SMSC converts the adding program message into an adding program short message, and sends the adding program short message to the UE.

Block 203: The UE acquires the multicast program address from the adding program short message and records the multicast program address.

In the embodiments of the present invention, the OTA, SMSC and UE are all subsystems for implementing a short message service in the mobile commutation network. The OTA may send a Submit_SM containing a source address and short message content to the SMSC by the Short Message Peer to Peer (SMPP) protocol. The source address is an initial address of sending the Submit_SM and may be taken as an identifier of updating a program bookmark list set in the UE. The SMSC converts the Submit_SM sent by the OTA into a short message, and sends the short message to the UE by the No. 7 signaling protocol.

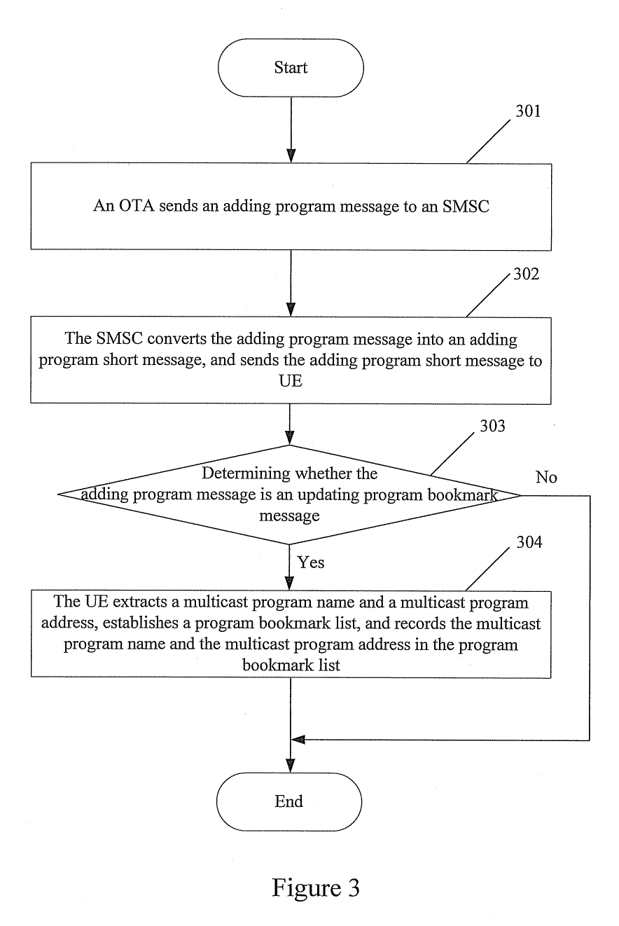

FIG. 3 is a flow chart of illustrating a method for acquiring a multicast program address in accordance with an embodiment of the present invention. In the present embodiment, the OTA may send an updating program bookmark message to the UE, and the format of the updating program bookmark message complies with the SMPP protocol. In the embodiment, the format of a source address field and a short message content field in the updating program bookmark message is as shown in Table 1.

TABLE 1

| | Short message content | | |
|---|---|---|---|
| Source | Multicast | Multicast | Operation |
| address | program name | program address | type |
| . . . | . . . | . . . | . . . |

The source address is an initial address of sending the updating program bookmark message, and is taken as an identifier of updating program bookmark message. Upon the receipt of a short message, the UE may determine whether the short message is an updating program bookmark message according to the source address, then perform appropriate processing.

Further, operation types may be categorized into three classes, i.e. adding, modifying and deleting. According to different operation types, the updating program bookmark message may be referred to as an adding program message, a modifying program message and a deleting program message, respectively. Because the adding program message, the modifying program message and the deleting program message are all updating program bookmark messages, and the values in their respective source address fields are the same, the UE may determine message type according to the source address and the operation type.

As shown in FIG. 3, the method for the UE acquiring a multicast program address in the present embodiment includes following processes.

Block 301: An OTA sends an adding program message containing a multicast program name and a multicast program address to an SMSC.

In the present embodiment, if the OTA and the UE define a Submit_SM of which the source address is 111 as an identifier of updating program bookmark message, and set the operation type as adding, the updating program bookmark message is an adding program message in this manner.

The source address and short message content fields of the adding program message generated by the OTA are shown in Table 2.

TABLE 2

| | Short message content | | |
|---|---|---|---|
| | | | Opera- |
| Source | Multicast | Multicast | tion |
| address | program name | program address | type |
| 111 | Finance and | rtsp://192.168.0.95.financenews.sdp | Adding |
| | economics | | |
| | information | | |

Block 302: The SMSC converts the adding program message into an adding program short message, and sends the adding program short message to the UE.

Block 303: The UE determines whether the adding program short message is an updating program bookmark message according to the source address, if the adding program short message is an updating program bookmark message, Block 304 is performed; otherwise, the flow terminates.

Block 304: The UE acquires the multicast program name and the multicast program address, establishes a program bookmark list, and records the multicast program name and the multicast program address in the program bookmark list.

The program bookmark list in which the UE records the multicast program name and the multicast program address in the embodiment is shown in Table 3.

TABLE 3

| Multicast program name | Multicast program address |
|---|---|
| Finance and economics | rtsp://192.168.0.95.financenews.sdp |
| information | |

In practical applications, the UE may perform the multicast service directly by acquiring the multicast program address if the UE does not need the multicast program name. For example, when the UE acquires a multicast node name corresponding to a certain multicast program address in advance, the multicast program name may not be contained in the updating program bookmark message.

In practical applications, after the UE establishes a program bookmark list, the OTA may send an updating program bookmark message to the UE for several times via the SMSC, i.e., the OTA may send an adding program message, a modifying program message or a deleting program message, and then the UE updates the program bookmark correspondingly according to the updating program bookmark message.

When the OTA sends an adding program message to the UE, the method for the UE updating the program bookmark according to the adding program message includes: the UE acquires the multicast program name and the multicast program address from the adding program message, and records the multicast program name and the multicast program address in the program bookmark list.

When the OTA sends a modifying program message to the UE, the method for the UE updating the program bookmark according to the modifying program message includes: acquires the multicast program name and multicast program address from the modifying program message, and changes the multicast program address corresponding to the multicast program name in the program bookmark list into the multicast program address acquired from the modifying program message.

When the OTA sends a deleting program message to the UE, the method for the UE updating the program bookmark according to the deleting program message includes: the UE acquires the multicast program name and multicast program address from the deleting program message, and deletes the multicast program name and multicast program address in the program bookmark list according to the multicast program name and multicast program address acquired from the deleting program message.

In the embodiment of the present invention, the OTA sends the updating program bookmark message to the SMSC first, and then after converting the updating program bookmark message into a short message, the SMSC sends the short message to the UE. So actually, the updating program bookmark message received by the UE is an updating program bookmark message converted into a short message. For the convenience of description, it may be described as the OTA sending an updating program bookmark message to the UE, which means the same.

Additionally, in practice applications, in order to acquire the multicast program address, it is necessary to perform corresponding function design for the UE. There is no strict limit to the function design, as long as the message may be determined as an updating program bookmark message and the multicast program name and the multicast program address may be acquired from the received message.

By the solution of the present invention, the UE may directly choose multicast programs saved in the local bookmark program list during a multicast service, so as to implement the multicast service. The UE may also designate a certain multicast program in the bookmark program list as a default multicast program. In this case, a mobile user may directly perform the multicast service without choosing a multicast program in the program bookmark list during the multicast service, so as to implement the “Push to Talk” service.

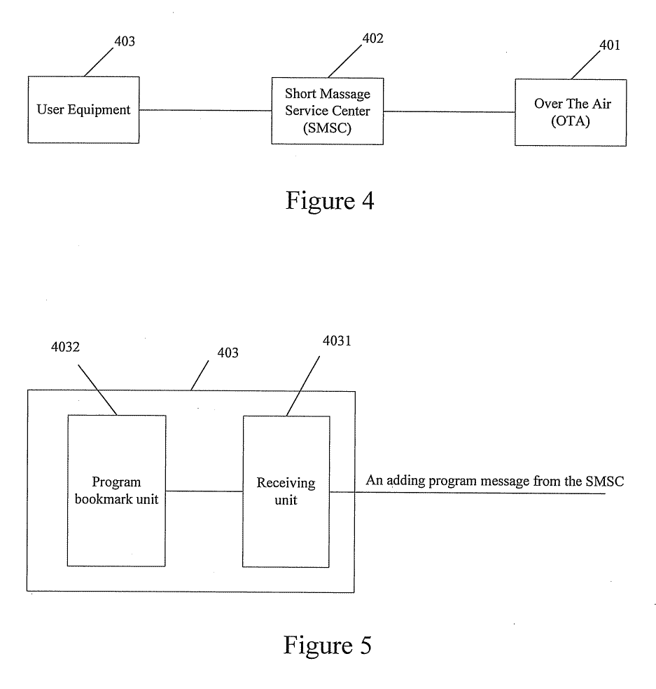

On the basis of the method for UE to acquire a multicast program address, an embodiment of the present invention also provides a system for acquiring a multicast program address. FIG. 4 is a schematic diagram illustrating a system for acquiring a multicast program address. As shown in FIG. 4, the system includes:

OTA 401, capable of sending an adding program message containing a multicast program address to SMSC 402;

SMSC 402, capable of converting the received adding program message into a short message, and sending the short message to UE;

UE 403, capable of receiving the adding program message converted into the short message from SMSC 402, and acquiring the multicast program address.

FIG. 5 is a schematic diagram illustrating the internal architecture of UE 403 described in FIG. 4. As shown in FIG. 5, UE 403 includes:

receiving unit 4031, capable of receiving an adding program message from the SMSC, and sending the adding program message to program bookmark unit 4032;

program bookmark unit 4032, capable of receiving the adding program message from receiving unit 4031, acquiring a multicast program name and a multicast program address, establishing a program bookmark list and recording the acquired multicast program name and multicast program address in the program bookmark list.

The foregoing descriptions are only preferred embodiments of this invention and are not for use in limiting the protection scope thereof. Any modification, equivalent replacement and improvement made under the spirit and principle of the present invention should be included in the protection scope thereof.

What is claimed is:

1. A method for acquiring a multicast program address, the method comprising:
receiving, via a Short Massage Service Center (SMSC), an updating program bookmark message containing a multicast program address from an Over The Air (OTA);
acquiring the multicast program address from the updating program bookmark message.

2. The method of claim 1, wherein receiving, via an SMSC, an updating program bookmark message containing a multicast program address from an OTA comprises:
sending, by the OTA, the updating program bookmark message containing the multicast program address to the SMSC;
converting, by the SMSC, the updating program bookmark message into an updating program bookmark short massage;
receiving the updating program bookmark short message from the SMSC.

3. The method of claim 1, wherein the updating program bookmark message further contains a multicast program name corresponding to the multicast program address; the method further comprises:
acquiring the multicast program name from the updating program bookmark message.

4. The method of claim 3, further comprising:
updating a program bookmark list for storing the multicast program name and the multicast program address according to the multicast program name and the multicast program address.

5. The method of claim 4, wherein the updating program bookmark message is an adding program message;
updating a program bookmark list according to the multicast program name and the multicast program address comprises:
acquiring the multicast program name and the multicast program address from the adding program message, and recording the multicast program name and the multicast program address in the program bookmark list.

6. The method of claim 4, wherein the updating program bookmark message is a modifying program message;
updating a program bookmark list according to the multicast program name and the multicast program address comprises:
acquiring the multicast program name and the multicast program address from the modifying program message, and changing the multicast program address corresponding to the multicast program name in the program bookmark list into the multicast program address acquired from the modifying program message.

7. The method of claim 4, wherein the updating program bookmark message is a deleting program message;
updating a program bookmark list according to the multicast program name and the multicast program address comprises:
acquiring the multicast program name and the multicast program address from the deleting program message, and deleting the multicast program name and the multicast program address in the program bookmark list according to the multicast program name and the multicast program address acquired from the deleting program message.

8. A system for acquiring a multicast program addresses, the system comprising:
an Over The Air (OTA), capable of sending an updating program bookmark message containing a multicast program address;
User Equipment (UE), capable of receiving the updating program bookmark message from the OTA via a Short Massage Service Center (SMSC), and acquiring the multicast program addresses.

9. The system of claim 8, wherein the SMSC converts the updating program bookmark message into an updating program bookmark short message, and sends the updating program bookmark short message to the UE.

10. The system of claim 8, wherein the updating program bookmark message further contains a multicast program name corresponding to the multicast program address;
the UE acquires the multicast program name from the updating program bookmark message, and updates a program bookmark list for storing the multicast program name and the multicast program address according to the multicast program name and the multicast program address.

11. An apparatus for acquiring a multicast program address, comprising:
a first unit, capable of receiving an updating program bookmark message containing a multicast program address from an Over The Air (OTA) via a Short Massage Service Center (SMSC);
a second unit, capable of acquiring the multicast program address from the updating program bookmark message received by the first unit.

12. The apparatus of claim 11, wherein the updating program bookmark message further contains a multicast program name corresponding to the multicast program address;
the second unit acquires the multicast program name from the updating program bookmark message received by the first unit.

13. The apparatus of claim 12, wherein the second unit updates a program bookmark list for storing the multicast program name and the multicast program address according to the acquired multicast program name and multicast program address.

14. The apparatus of claim 13, wherein the updating program bookmark message is an adding program message;
the second unit records the multicast program name and the multicast program address in the program bookmark list.

15. The apparatus of claim 13, wherein the updating program bookmark message is a modifying program message;
the second unit changes the multicast program address corresponding to the multicast program name in the program bookmark list into the multicast program address acquired from the modifying program message.

16. The apparatus of claim 13, wherein the updating program bookmark message is a deleting program message;
the second unit deletes the multicast program name and the multicast program address in the program bookmark list according to the multicast program name and the multicast program address acquired from the deleting program message.
